(19) United States
(12) Patent Application Publication
(10) Pub. No.: US 2020/0167716 A1
(43) Pub. Date: May 28, 2020

(54) MAINTENANCE MANAGEMENT APPARATUS

(71) Applicant: TOSHIBA TEC KABUSHIKI KAISHA, Tokyo (JP)

(72) Inventor: Tomoyuki OTSU, Mishima Shizuoka (JP)

(21) Appl. No.: 16/656,847

(22) Filed: Oct. 18, 2019

(30) Foreign Application Priority Data
Nov. 26, 2018 (JP) 2018-220269

(51) Int. Cl. G06Q 10/06; G06Q 10/00; G06Q 10/10; H04W 4/12

(52) U.S. Cl. CPC G06Q 10/063114; G06Q 10/20; G06Q 10/063112; H04W 88/02; G06Q 10/06393; G06Q 10/103; H04W 4/12; G06Q 10/06312

(57) ABSTRACT

A maintenance management apparatus that is in communication with portable terminals of workers includes a communication interface, and a processor. Based on the data received through the communication interface from the portable terminals, the processor estimates a current progress state of assigned work tasks being performed by the workers. The current progress state of each assigned work task is estimated based upon an average completion time for each worker, a start time of the assigned work task currently being performed by each worker, and the current time, and selects a second worker to assist a first worker currently performing an assigned work task based upon the estimated current progress state of the assigned work task of the second worker, a distance between the first and second workers, and information indicating an ability of the second worker with respect to the assigned work task of the first worker.

### CROSS-REFERENCE TO RELATED APPLICATION

This application is based upon and claims the benefit of priority from Japanese Patent Application No. 2018-220269, filed in Nov. 26, 2018, the entire contents of which are incorporated herein by reference.

### FIELD

Embodiments described herein relate generally to a maintenance management apparatus.

### BACKGROUND

In a related art, a maintenance person can be selected to fix an apparatus based upon experience, prior results, the distance between the maintenance person and the apparatus site.

However, in the related art, a maintenance person considered capable fixing the apparatus can be identified, but when that maintenance person is currently working, then a maintenance person cannot always be promptly dispatched.

### DESCRIPTION OF THE DRAWINGS

FIG. 1 is a diagram depicting a maintenance management system.

FIG. 2 is a hardware block diagram depicting a hardware configuration of a server apparatus.

FIG. 3 is a hardware block diagram depicting a hardware configuration of a portable terminal.

FIG. 4 is a functional block diagram depicting aspects of a portable terminal.

FIG. 5 is a diagram illustrating an example of a work log file.

FIG. 6 is a functional block diagram depicting aspects of a server apparatus.

FIG. 7 is a diagram illustrating an example of a work assignment file.

FIG. 8 is a diagram illustrating an example of a work result file in which an average work time, and the like of each worker are recorded.

FIG. 9 is a diagram illustrating an example of a standard work time file in which a standard work time of each work is recorded.

FIG. 10 is a diagram illustrating an example of a screen for confirming the necessity of an assistance request that is displayed on a portable terminal of a worker whose work is estimated to be delayed.

FIG. 11 is a flowchart of processing for calculating an average work time of a worker.

FIG. 12 is a flowchart of processing performed by a maintenance management system.

FIG. 13 is a flowchart of work assignment processing.

FIG. 14 is a flowchart of assistant selection processing.

### DETAILED DESCRIPTION

In general, according to one embodiment, a maintenance management apparatus that is in communication with a plurality of portable terminals of workers includes a communication interface through which data are exchanged with the portable terminals, and a processor. Based on the data received through the communication interface from the portable terminals, the processor estimates a current progress state of assigned work tasks being performed by each of a plurality of workers. The current progress state of each assigned work task is estimated based upon an average completion time for each worker with respect to work tasks of a same work type as the assigned work task, a start time of the assigned work task currently being performed by each worker, and the current time. The processor can then select a second worker from the plurality of workers to assist a first worker that is currently performing an assigned work task that has a current progress state that is estimated as being delayed. The selection of the second worker is based upon the estimated current progress state of the assigned work task of the second worker, a distance between the first worker and the second worker, and information indicating an ability of the second worker with respect to the same work type as the assigned work task of the first worker.

Schematic Configuration of a Maintenance Management System

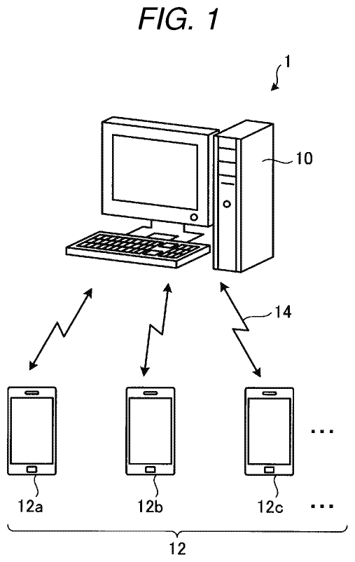

Hereinafter, example embodiments will be described with reference to the accompanying drawings. FIG. 1 is a diagram illustrating an example of a configuration of a maintenance management system 1. The maintenance management system 1 is a system that manages/monitors the progress of the work of a plurality of workers. When it is estimated that the work or task of a certain worker (referred to below as worker Q or the first worker) is delayed, the maintenance management system 1 confirms whether or not assistance (or additional support) is necessary for the worker Q so as to avoid or mitigate delays in the completion of the work or task. When the worker Q requires assistance, the maintenance management system 1 selects another appropriate worker (referred to below as a worker S, a second worker, or assistant) who can provide the assistance to worker Q. The particular worker S can be selected from among several other potential workers R. The selected worker R (that is, worker S) provides assistance to worker Q to complete the work/task of worker Q. Together, worker Q, worker S, and workers R are collectively referred to as the workers T.

The maintenance management system 1 includes portable terminals 12 (12a, 12b, 12c, . . . ) for each of the workers T and a server apparatus 10.

The server apparatus 10 controls the overall operations of the maintenance management system 1. Specifically, the server apparatus 10 estimates a progress state of the current work of all the workers T. Further, the server apparatus 10 confirms whether or not the assistance of work is necessary for the worker Q whose work progress has been estimated to be delayed. Further, the server apparatus 10 can receive an assistance request from the worker Q, and then select a worker S to assists the worker Q from among the workers R.

Each portable terminal 12 (12a, 12b, 12c, . . . ) is an information processing terminal apparatus including a communication function such as, for example, a smart phone or a tablet computer, or the like. The portable terminals 12 respectively belong to the workers T. A portable terminal 12 generates a work log, which is a work history of each of the workers T, including a work type (content), a start time of the work, and an end time thereof which are respectively inputted by the workers T. Further, a portable terminal 12 is respectively associated with each worker T. That is, when a particular portable terminal 12 is specified, the worker T who owns the specified portable terminal is uniquely determined. Further, the portable terminals 12 communicates with the server apparatus 10 by a wireless communication network 14, and thereby transmits and receives various data, various files, and the like.

Hardware Configuration of a Server Apparatus

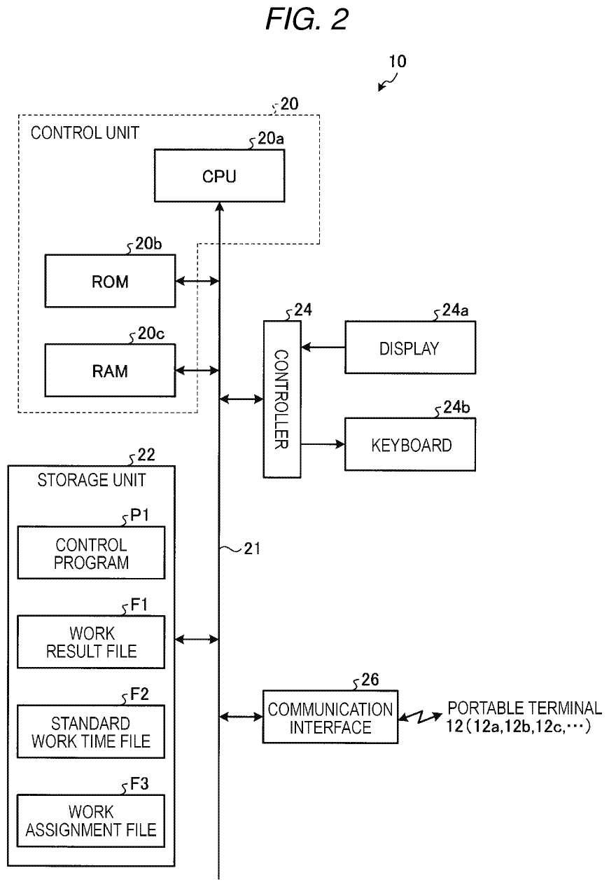

FIG. 2 is a block diagram illustrating an example of the hardware configuration of the server apparatus 10. The server apparatus 10 includes a control unit 20 for controlling each unit. The control unit 20 includes a CPU (Central Processing Unit) 20a, a ROM (Read Only Memory) 20b, and a RAM (Random Access Memory) 20c. The CPU 20a is connected to the ROM 20b and the RAM 20c via a bus line 21. The CPU 20a executes various programs stored in the ROM 20b or storage unit 22 by loading them in the RAM 20c. The CPU 20a controls the server apparatus 10 according to various programs loaded in the RAM 20c. That is, the control unit 20 can be a general computer in configuration.

The control unit 20 is connected to the storage unit 22, a controller 24, and a communication interface 26 via the bus line 21.

The storage unit 22 is a non-volatile memory such as a flash memory or an HDD (Hard Disk Drive) in which storage information is stored even when the power supply is turned off. The storage unit 22 stores programs including a control program P1. The control program P1 is program instructions for implementing functions provided in the server apparatus 10. The storage unit 22 also stores a work result file F1, a standard work time file F2, and a work assignment file F3.

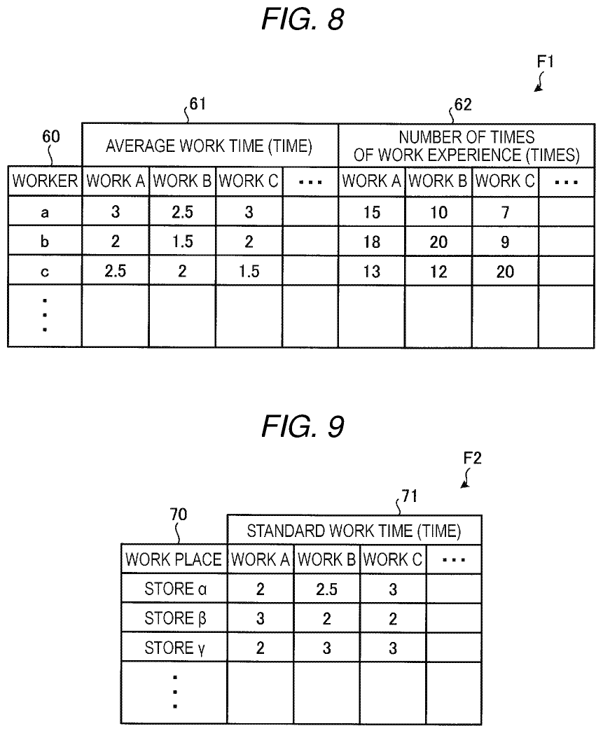

The work result file F1 is a file storing an average work time 61 for each job/task type of a worker and the number of times the worker has performed the job/task (work experience 62) of the work are stored. The work result file F1 is generated based upon a content of a work log file F4 (FIG. 5) generated by the portable terminal 12. Additional details thereof will be described below (see FIG. 8).

The standard work time file F2 is a file in which a standard work time 71 considered to be required or appropriate for each work type is stored for each of a plurality of stores or worksites. Additional details thereof will be described below (see FIG. 9).

The work assignment file F3 is a file storing a work content 51b that has been respectively assigned to each of the workers T. Additional details thereof will be described below (see FIG. 7).

The controller 24 is connected to a display 24a and a keyboard 24b. The controller 24 controls various connected hardware based upon a command from the control unit 20.

The display 24a displays image information, text information, and the like as output from the server apparatus 10. The display 24a is, for example, a liquid crystal monitor or an organic EL monitor, or the like.

The keyboard 24b permits an input of necessary information and operation instructions to the server apparatus 10 so the server apparatus 10 can perform various kinds of processing. Further, a touch panel laminated on the screen of the display 24a may be used instead of or in addition to the keyboard 24b.

The communication interface 26 is an interface for communicating with the portable terminal 12 via wireless communication such as, for example, a wireless LAN, or the like.

Hardware Configuration of a Portable Terminal

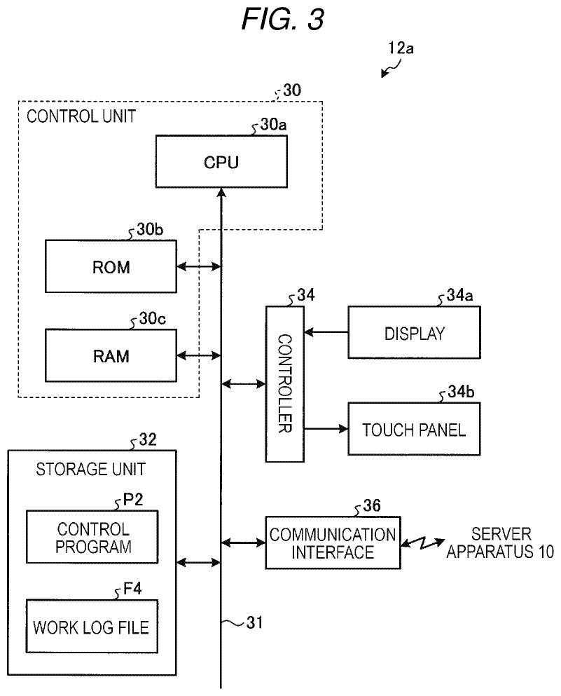

Next, a hardware configuration of the portable terminal 12 (will be described. FIG. 3 is a hardware block diagram illustrating an example of a hardware configuration of the portable terminal 12a. Since all the portable terminals 12 (12a, 12b, 12c, can have the same hardware configuration, the following description will be performed using the portable terminal 12a as a representative example of all the portable terminals 12.

The portable terminal 12a includes a control unit 30 for controlling each unit. The control unit 30 includes a CPU 30a, a ROM 30b, and a RAM 30c. The CPU 30a is connected to the ROM 30b and the RAM 30c via a bus line 31. The CPU 30a executes various programs stored in the ROM 30b or a storage unit 32 using the RAM 30c. The CPU 30a controls the portable terminal 12a according to various programs loaded in the RAM 30c. That is, the control unit 30 can have a general computer configuration and be configured according to executed software programs.

The control unit 30 is connected to the storage unit 32, a controller 34, and a communication interface 36 via the bus line 31.

The storage unit 32 is a non-volatile memory such as a flash memory, or the like in which storage information is stored even when the power supply is turned off. The storage unit 32 stores a control program P2. The control program P2 includes program instructions which when executed cause the portable terminal 12a to provide various functions. The storage unit 32 also stores the work log file F4.

The work log file F4 is a file in which information representing a progress state a worker in performing work/tasks is stored. Additional, details thereof will be described below (see FIG. 5).

The controller 34 is connected to a display 34a and a touch panel 34b. The controller 34 controls various connected hardware based upon commands from the control unit 30.

The display 34a displays image information, text information, and the like as output from the portable terminal 12a. The display 34a is, for example, a liquid crystal monitor or an organic EL monitor, or the like.

The touch panel 34b can be used to provide inputs of necessary information and operation instructions when the portable terminal 12a performs various kinds of processing.

The communication interface 36 is an interface for communicating with the server apparatus 10 via wireless communication such as a wireless LAN, and the like.

Functional Configuration of a Portable Terminal

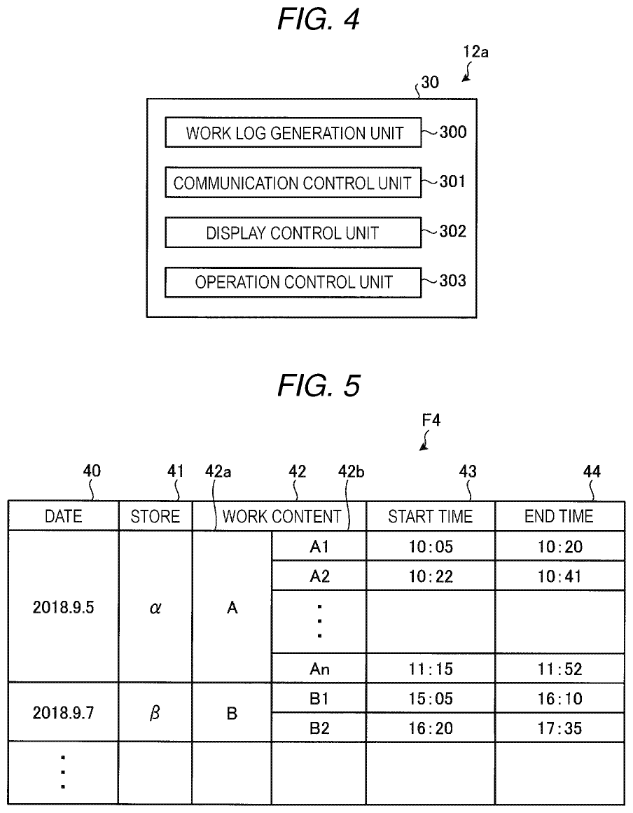

FIG. 4 is a functional block diagram illustrating an example of a functional configuration of the portable terminal 12a.

The control unit 30 of the portable terminal 12a loads the control program P2 in the RAM 30c and executes the control program P2, thereby realizing a work log generation unit 300, a communication control unit 301, a display control unit 302, and an operation control unit 303, all of which are illustrated in FIG. 4 as functional units.

The work log generation unit 300 generates the work log file F4 (see FIG. 5).

The communication control unit 301 controls wireless communication for exchanging information with the server apparatus 10. Specifically, the communication control unit 301 receives a transmission request for the work log file F4 from the server apparatus 10 and then transmits the work log file F4 to the server apparatus 10. The communication control unit 301 also transmits a start time 43 and an end time 44 for work (see FIG. 5) to the server apparatus 10. The communication control unit 301 also transmits an assistance request to the server apparatus 10.

The display control unit 302 generates display information to be displayed on the display 34a. The display control unit 302 displays the generated display information on the display 34a.

The operation control unit 303 receives operation information from the touch panel 34b and transfers the received operation information to the control unit 30. Thereafter, the control unit 30 is caused to perform processing corresponding to the operation of the touch panel 34b.

Work Log File

FIG. 5 is a diagram illustrating an example of a work log file F4. The work log file F4 records a date 40, a store name 41, a work content 42, the start time 43, and the end time 44. The work log file F4 is input from the portable terminal 12a owned by worker Q. Likewise, each portable terminal 12 of the workers R other than the worker Q provide information. Hereinafter, a case in which the worker Q inputs the work log file F4 will be described.

The date 40 records the date on which the work was performed. With respect to the date 40, for example, when a work assignment is performed, the date on which the assigned work was performed is input to the portable terminal 12a, after which the input date is recorded in the work log file F4.

The store name 41 records the name of the store where the work was performed. With respect to the store name 41, for example, when the work assignment is performed, the name of the store where the assigned work is performed is input to the portable terminal 12a, after which the name of the store is recorded in the work log file F4.

The work content 42 records information indicating the content of the work. The work content 42 comprises, for example, an upper classification 42a and a lower classification 42b. The upper classification 42a is, for example, the name of the work type or class, and the like. The lower classification 42b is, for example, the name of the a sub-type, sub-part, or sub-class of the upper classification, and the like forming one task. With respect to the work content 42, for example, when the work assignment is performed, the assigned work content is input to the portable terminal 12a, after which the assigned work content is recorded in the work log file F4.

The start time 43 records the time when the work starts. When starting the work, the worker Q opens the work log file F4 of the portable terminal 12a and inputs the start time 43. Specifically, for example, when the worker Q presses down the corresponding column of the start time 43, the portable terminal 12a may read the current time from the CPU 30a and may record the current time read therefrom in the corresponding column of the start time 43.

The end time 44 records the time when the work is completed. When the work is completed, the worker Q opens the work log file F4 of the portable terminal 12a and inputs the end time 44. Specifically, for example, when the worker Q presses down the corresponding column of the end time 44, the portable terminal 12a may read the current time from the CPU 30a and may record the current time read therefrom in the corresponding column of the end time 44.

While a specific example will not be described, when the start time 43 and the end time 44 are being recorded, the operation control unit 303 of the portable terminal 12a may include a GUI (Graphical User Interface) for performing confirmation or cancellation after the time is recorded in the corresponding column of the work log file F4 if the inputted time is in error.

Functional Configuration of a Sever Apparatus

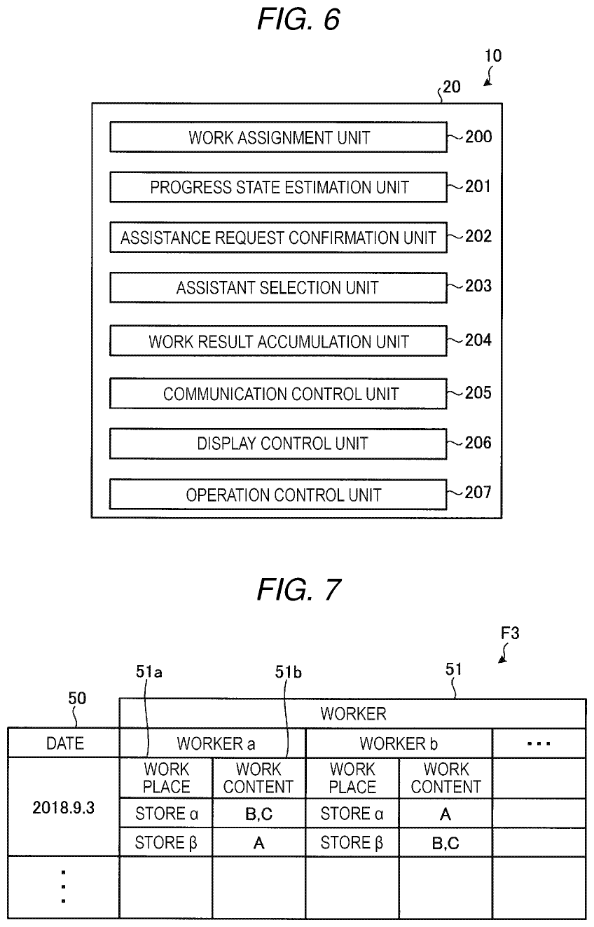

FIG. 6 is a functional block diagram illustrating an example of the server apparatus 10. The control unit 20 of the server apparatus 10 loads and executes the control program P1 (FIG. 3) in the RAM 20c, thereby realizing a work assignment unit 200, a progress state estimation unit 201, an assistance request confirmation unit 202, an assistant selection unit 203, a work result accumulation unit 204, a communication control unit 205, a display control unit 206, and an operation control unit 207.

The work assignment unit 200 identifies a worker to be assigned to a work type based upon a standard work time required for completing the work and the average work times 61 of all the workers T for the work type. The work assignment unit 200 is an example of an assignment unit.

The progress state estimation unit 201 estimates the progress state of the current work of all the workers T based upon the past average work time 61 for the pieces of work presently assigned to each of the workers T, the start time 43 of the work currently being performed by each worker, and the current time. The progress state estimation unit 201 is an example of an estimation unit.

The assistance request confirmation unit 202 confirms whether or not the assistance of the work is necessary for the worker Q whose work progress is estimated to be delayed. Further, the assistance request confirmation unit 202 is an example of a confirmation unit.

The assistant selection unit 203 selects the worker S who is to assist the worker Q from among the workers R based upon information on the progress state of the present work of the worker R, information on the distance between the worker Q and the worker R, and information on the ability of the worker R. Further, the assistant selection unit 203 is an example of a selection unit.

Here, the information on the progress state of the work of the worker R is, for example, a remaining work time for the work currently being performed by the worker R. Further, the information on the distance between the worker Q and the worker R is, for example, the estimated time required for the worker R to travel to assist the worker Q. The information on the ability of the worker R is, for example, the work experience of worker R with respect to the work presently being performed by the worker Q.

The assistant selection unit 203 selects the worker S who is to assist the worker Q if the worker Q replies that assistance is necessary in response to the confirmation of the assistance request confirmation unit 202. Furthermore, the assistant selection unit 203 calls the particular worker S selected from among the workers R to indicate assistance is desired for worker Q. The assistant selection unit 203 is one example of a selection unit.

The work result accumulation unit 204 generates the work result file F1 for all the workers T by referring to the work log files F4 of all the workers T. Further, the work result accumulation unit 204 calculates the average work time 61 of each work type based upon the start times 43 and the end times 44 of all the workers T performing the same work type in the past.

The communication control unit 205 controls wireless communication for exchanging information with the portable terminal 12a. Specifically, the communication control unit 205 requests the portable terminal 12a to transmit the work log file F4, and receives the work log file F4 from the portable terminal 12a. Further, the communication control unit 205 receives the start time 43 and the end time 44 from the portable terminal 12a. Further, the communication control unit 205 receives the assistance request from the portable terminal 12a. The communication control unit 205 is an example of a receiving unit.

The display control unit 206 generates display information to be displayed on the display 24a. Further, the display control unit 206 displays the generated display information on the display 24a.

The operation control unit 207 receives operation information from the keyboard 24b and transfers the operation information to the control unit 20. Thereafter, the control unit 20 is caused to perform processing corresponding to the input operation of the keyboard 24b.

Work Assignment File

FIG. 7 is a diagram illustrating an example of the work assignment file F3. The work assignment file F3 records the date 50 and worker information 51.

The date 50 records the date on which the work is to be performed. The date assigned is recorded in the work assignment file F3.

The worker information 51 records a work place 51a and the work content 51b for each worker. The work place 51a is information for specifying a work place, and records, for example, a store name, and the like. The work content 51b is information for specifying a work content. When a plurality of pieces of work are assigned, a plurality of work contents is recorded.

Work Result File

FIG. 8 is a diagram illustrating an example of the work result file F1 in which the average work time 61, and the like of all the workers T are respectively recorded. The work result file F1 records the worker information 60, the average work time 61, and the work experience 62.

The worker information 60 is information for specifying each worker, and records, as an example, a worker identification number, or the like. The average work time 61 records the average work time of each work type performed by the corresponding worker in the past. The work experience 62 records the number of times the corresponding worker has performed the work type in the past.

The work result file F1 is updated, for example, when the server apparatus 10 receives the work log file F4 from the portable terminal 12a. Alternatively, the work result file F1 may be updated at a scheduled timing such as 17:00 every day.

As an example, it is assumed that a “worker a” completes “work A” in two hours. In the work result file F1 before the update illustrated in FIG. 8, since the average work time of the work A of the worker a is recorded as 3 hours and the number of times the work A has been performed by worker a is recorded as 15 times, the new average work time 61 is thus calculated as 2.9 hours ((3 hours×15 times+2 hours)/16 times). Next, the calculated average work time and work experience number are overwritten on the work result file F1, and the work result file F1 is updated with the new values (2.9 hrs. and 16 times).

The work result file F1 of FIG. 8 can be used to calculate the average work time by collecting pieces of work performed at all different work places, but the work result for each work place may be separately recorded.

Standard Work Time File

FIG. 9 is a diagram illustrating an example of the standard work time file F2 in which the standard work time of each work type is recorded. The standard work time file F2 records a work place 70 and a standard work time 71.

The work place 70 is information for specifying a work place, and records, for example, a store name. The standard work time 71 records a standard work time for each work content. For example, when a worker having a standard work ability performs the corresponding work in the corresponding store, the standard work time is defined as the expected time required from the start of the work to the completion of the work. For example, the standard work time is set by combining work contents and work procedures of each work type when the work contents and work procedures thereof are set.

Assistance Confirmation Screen

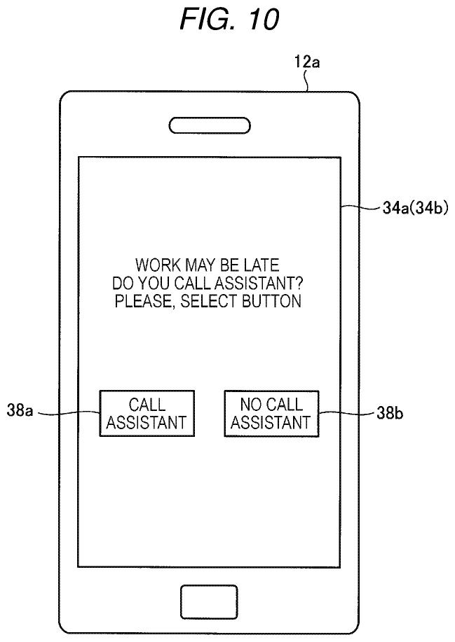

Next, a method of confirming the necessity of work assistance for the worker Q whose work has been estimated to be delayed will be described with reference to FIG. 10. FIG. 10 is a diagram illustrating an example of a screen for confirming the necessity of an assistance request to be displayed on the portable terminal 12a of the worker Q whose work has been estimated to be delayed.

On the display 34a of the portable terminal 12a, a message is displayed indicating that the present work is estimated as delayed and a request that the worker Q make a selection as to whether or not an assistant is necessary.

Further, display 34a displays thereon an assistance request button 38a for requesting an assistant and an assistance unnecessary button 38b for indicating that an assistant is not necessary. When the touch panel 34b of the portable terminal 12a detects that the assistance request button 38a is pressed, information indicating that an assistant is requested is transmitted to the server apparatus 10. When the touch panel 34b detects that the assistance unnecessary button 38b is pressed, information indicating that the assistant is unnecessary is transmitted to the server apparatus 10.

Average Work Time Calculation Processing

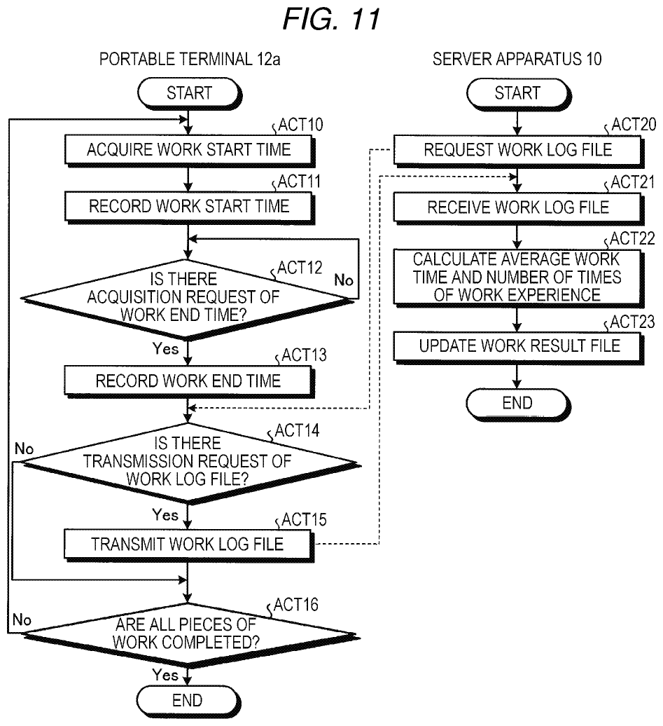

Next, a calculation method of the average work time 61 recorded in the work result file F1 will be described. FIG. 11 is a flowchart illustrating an example of processing for calculating the average work time 61 of the worker Q.

First, a flow of processing of the portable terminal 12a will be described. The operation control unit 303 detects that a column indicating the start time 43 of the work content 42 is pressed in the work log file F4, and acquires the time when the column is pressed, for example, from a timer of the CPU 30a (ACT 10).

The work log generation unit 300 records the acquired time in the column of the work log file F4 (ACT 11).

The operation control unit 303 determines whether or not there is an acquisition request for the end time 44 of the work currently being performed (ACT 12). Specifically, the operation control unit 303 determines that there is the acquisition request of the end time 44 when detecting that the column indicating the end time 44 of the work currently being performed is pressed in the work log file F4. When it is determined that there is the acquisition request of the end time 44 (ACT 12: Yes), the processing proceeds to ACT 13. On the other hand, when there is not an acquisition request for the end time 44 (ACT 12: No), the processing repeats ACT 12.

When acquisition of the end time 44 is requested in ACT 12, for example, the work log generation unit 300 records the time acquired from the timer of the CPU 30a in the pressed column of the work log file F4 (ACT 13).

The communication control unit 301 determines whether or not there is a transmission request for the work log file F4 from the server apparatus 10 (ACT 14). When it is determined that there is the transmission request for the work log file F4 (ACT 14: Yes), the processing proceeds to ACT 15. On the other hand, when there is not a transmission request for the work log file F4 (ACT 14: No), the processing proceeds to ACT 16.

In ACT 14, when it is determined that there is the transmission request for the work log file F4, the communication control unit 301 transmits the work log file F4 to the server apparatus 10 (ACT 15).

Next, in ACT 16, the work log generation unit 300 determines whether or not all the pieces of work are completed. Further, the completion of all the pieces of work may be determined by a fact that the start time 43 and the end time 44 of the work corresponding to the work content 42 to be performed on the day are all recorded in the work log file F4. Next, when it is determined that all the pieces of work are completed (ACT 16: Yes), the portable terminal 12a terminates the processing of FIG. 11. On the other hand, when all the pieces of work are not completed (ACT 16: No), the processing returns to ACT 10.

Next, a flow of processing performed by the server apparatus 10 will be described. The work result accumulation unit 204 requests the portable terminal 12a to transmit the work log file F4 (ACT 20). The transmission request for the work log file F4 may be performed at a predetermined timing.

The communication control unit 205 receives the work log file F4 from the portable terminal 12a (ACT 21).

The work result accumulation unit 204 calculates the new average work time 61 and the new number of times of work experience 62 based upon the record content of the work result file F1 and the record content of the received work log file F4 (ACT 22).

The work result accumulation unit 204 updates the work result file F1 by overwriting the calculated new average work time 61 and the new number of times of work experience 62 on the work result file F1 (ACT 23). Then, the server apparatus 10 terminates the processing of FIG. 11.

Flow of Processing Performed by a Maintenance Management System

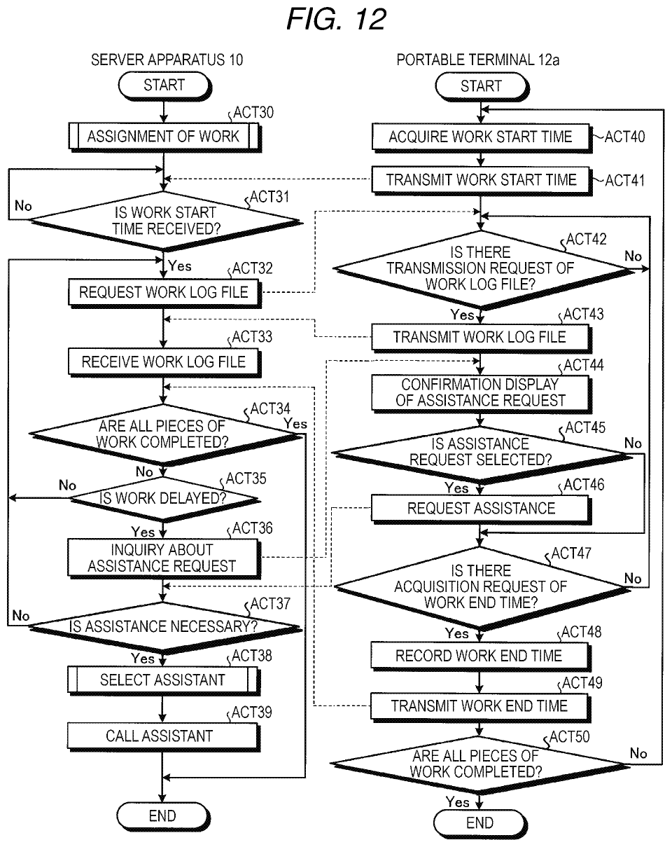

FIG. 12 is a flowchart illustrating an example of processing performed by the maintenance management system 1. First, a flow of processing by the server apparatus 10 will be described. In general, the maintenance management system 1 manages the progress of the work for all the workers T, but in the following, to simplify the description, the functioning of the maintenance management system 1 will be described only with regard to aspects related to management of the progress of the work of the worker Q, who owns the portable terminal 12a. In general, maintenance management system 1 aspects related to any worker T are substantially similar to that described particularly for worker Q.

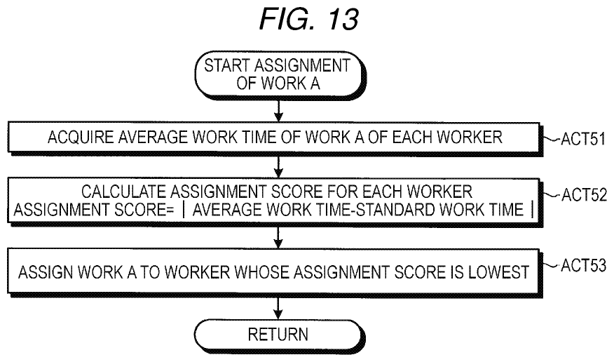

The work assignment unit 200 performs work assignment processing for assigning the work to all the workers T (ACT 30). A more detailed flow of the work assignment processing will be described below (see FIG. 13).

After the work assignment processing is completed, the progress state estimation unit 201 determines whether or not the start time 43 has been received from the portable terminal 12a (ACT 31). When it is determined that the start time 43 has been received (ACT 31: Yes), the processing proceeds to ACT 32. On the other hand, when the start time 43 is not yet received (ACT 31: No), the processing repeats ACT 31.

The progress state estimation unit 201 requests the portable terminal 12a to transmit the work log file F4 (ACT 32). The transmission request can be performed at a predetermined timing, for example, every 10 minutes.

The communication control unit 205 receives the work log file F4 from the portable terminal 12a (ACT 33).

The progress state estimation unit 201 determines whether or not all the different pieces of work are completed (ACT 34). When it is determined that all the pieces of work have been completed (ACT 34: Yes), the server apparatus 10 terminates the processing of FIG. 12. On the other hand, when all the pieces of work are not yet completed (ACT 34: No), the processing proceeds to ACT 35. The completion of all the pieces of work may be determined by a fact that start times 43 and end times 44 of all the work corresponding to the work content 42 scheduled to be performed on the day have all been recorded in the received work log file F4.

When all the pieces of work are not yet completed, the progress state estimation unit 201 determines whether or not the work is to be considered delayed in ACT 35. When it is determined that the work is considered delayed (ACT 35: Yes), the processing proceeds to ACT 36. On the other hand, when it is not determined that the work is to be considered delayed (ACT 35: No), the processing returns to ACT 32. Whether or not the work is to be considered delayed can be determined in such a manner as comparing the elapsed time, which is calculated by subtracting the start time 43 recorded in the work log file F4 from the current time, to the average work time 61 registered in the work result file F1. When the elapsed time exceeds the average work time 61, it may be determined that the work is delayed. Also, when the elapsed time exceeds the standard work time 71 registered in the standard work time file F2, it may be determined that the work is delayed.

When it is determined that the work is to be considered delayed in ACT 35, the assistance request confirmation unit 202 inquires via the communication control unit 205 about whether or not to make a work assistance request via the portable terminal 12a (ACT 36). Specifically, the server apparatus 10 causes the portable terminal 12a to display a screen for suggesting the necessity of requesting assistance and inquiring whether an assistance request is to be made. An example of such a screen is illustrated in FIG. 10.

Next, the communication control unit 205 receives a response from the portable terminal 12a, and the assistance request confirmation unit 202 determines whether or not the assistance is considered necessary (ACT 37). When it is determined that the assistance is necessary (ACT 37: Yes), the processing proceeds to ACT 38. On the other hand, when assistance is not necessary (ACT 37: No), the processing returns to ACT 32.

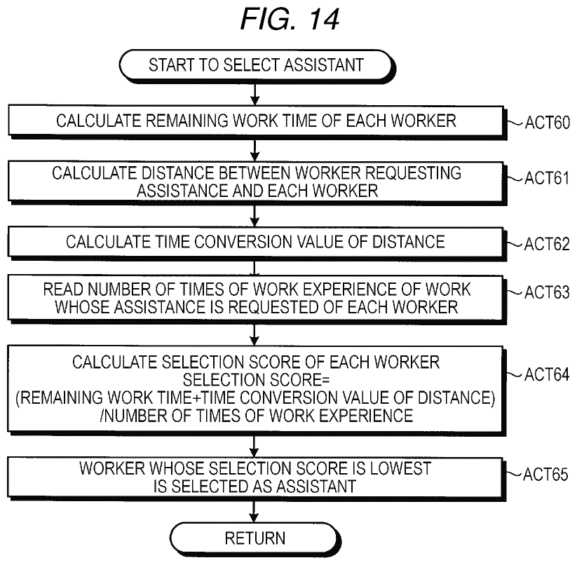

When it is determined that the assistance is necessary in ACT 37, the assistant selection unit 203 performs assistant selection processing for selecting an assistant (ACT 38). Additional aspects of the assistant selection processing will be below later (see FIG. 14).

Next, the assistant selection unit 203 causes the communication control unit 205 to call the selected assistant. Then, the server apparatus 10 terminates the processing of FIG. 12.

Further, even though not specifically illustrated in the flowchart of FIG. 12, in response to ACT 39, the server apparatus 10 causes the portable terminal of the selected worker S to display information to the effect that the work of the worker Q (owner the portable terminal 12a) is to be assisted by worker S. The called worker S then determines whether or not to respond positively to the assistance request. When the assistance is possible, the worker S goes to worksite of the worker Q and assists until the work currently being performed is completed.

Next, a flow of processing performed by the portable terminal 12a will be described. First, the operation control unit 303 detects that a column indicating the start time 43 of the work content 42 is pressed down in the work log file F4, and acquires the time when the column is pressed down, for example, from the timer (clock) of the CPU 30a (ACT 40). Further, the work log generation unit 300 records the acquired time in the pressed column of the work log file F4 as the start time 43.

Next, the work log generation unit 300 causes the communication control unit 301 to transmit the acquired start time 43 to the server apparatus 10 (ACT 41).

The communication control unit 301 determines whether or not there is a transmission request for the work log file F4 from the server apparatus 10 (ACT 42). When it is determined that there is the transmission request for the work log file F4 (ACT 42: Yes), the processing proceeds to ACT 43. On the other hand, when there is not a transmission request for the work log file F4 (ACT 42: No), the processing repeats ACT 42.

When it is determined that there is the transmission request for the work log file F4 in ACT 42, the communication control unit 301 transmits the work log file F4 to the server apparatus 10 (ACT 43).

When receiving an inquiry from the server apparatus 10 about whether or not the assistance request was made, the display control unit 302 performs the confirmation display of the assistance request (FIG. 10) on the display 34a (ACT 44). Further, the processing of ACT 44 is so-called interruption processing to be executed when receiving the inquiry about whether or not the assistance request was performed from the server apparatus 10. Therefore, the processing thereof is not necessarily executed at the position of ACT 44 of the flowchart of FIG. 12 but may be initiated at any time.

The operation control unit 303 determines whether or not the assistance request is selected (ACT 45). When it is determined that the assistance request is selected (ACT 45: Yes), the processing proceeds to ACT 46. On the other hand, when the assistance request is not selected (ACT 45: No), the processing proceeds to ACT 47. The operation control unit 303 determines that the assistance request is selected when it is detected that the assistance request button 38a was pressed down. When it is detected that the assistance unnecessary button 38b was pressed down, it is determined that the assistance request is not selected.

When it is determined that the assistance request is selected in ACT 45, the operation control unit 303 causes the communication control unit 301 to transmit information to the effect that assistance is necessary to the server apparatus 10 in ACT 46.

On the other hand, when the assistance request is not selected in ACT 45 or following ACT 46, the operation control unit 303 determines whether or not there is an acquisition request of the end time 44 of the work currently being performed (ACT 47). Specifically, the same determination as that of ACT 12 described above is performed. When it is determined that there is the acquisition request of the end time 44 (ACT 47: Yes), the processing proceeds to ACT 48. On the other hand, when there is not an acquisition request of the end time 44 (ACT 47: No), the processing returns to ACT 42.

In ACT 47, when the acquisition of the end time 44 is requested, the work log generation unit 300 records, for example, the time acquired from the timer of the CPU 30a in the pressed column of the work log file F4 (ACT 48).

Next, the work log generation unit 300 causes the communication control unit 301 to transmit the end time 44 to the server apparatus 10 (ACT 49).

Next, the work log generation unit 300 determines whether or not all the pieces of work are completed (ACT 50). Specifically, the same determination as that of ACT 16 described above is performed. When it is determined that all the pieces of work are completed (ACT 50: Yes), the portable terminal 12a terminates the processing of FIG. 12. On the other hand, when all the pieces of work are not yet completed (ACT 50: No), the processing returns to ACT 40.

Further, as indicated by the flowchart illustrated in FIG. 12, the server apparatus 10 is configured to inquire of the portable terminal 12a about whether or not assistance is necessary, and the server apparatus 10 is configured to select an assistant based upon the reply thereto. That is, the server apparatus 10 is an apparatus which selects the assistant according to the reply to the confirmation by the assistance request confirmation unit 202. However, the server apparatus 10 is not limited to the configuration described above.

That is, the assistant selection unit 203 may be configured to select the worker S on the condition that the communication control unit 205 of the server apparatus 10 receives the assistance request issued from the portable terminal 12a without waiting for the inquiry from the server apparatus 10.

Flow of Work Assignment Processing

FIG. 13 is a flowchart illustrating an example of a flow of the work assignment processing. In particular, FIG. 13 is a flowchart illustrating an example of a flow of processing for determining a worker to which a specific work A is to be assigned, and illustrates a detailed flow of the processing to be performed in ACT 30 of FIG. 12.

First, the work assignment unit 200 acquires the average work time of the work A of all the workers T from the work result file F1 (ACT 51).

Next, the work assignment unit 200 respectively calculates assignment scores of all the workers T (ACT 52). The assignment score is an example of an index value indicating an ability of the worker. Here, an absolute value of a difference between the average work time 61 of the work A and the standard work time 71 of the work A is defined as the assignment score. As a worker whose assignment score is lower, the worker can perform the work A in the time close to the standard work time 71, that is, it can be determined that the ability of the worker with respect to the work A is high. Further, in ACT 52, as a difference value obtained by subtracting the standard work time 71 of the work A from the average work time 61 of the work A is smaller, it may be simply determined that the ability of the worker with respect to the work A is high.

The work assignment unit 200 assigns the work A to a worker whose assignment score is the lowest (ACT 53). Thereafter, the processing proceeds to ACT 31 of FIG. 12.

Furthermore, since it is typically necessary to assign a plurality of pieces of work to each worker, the processing of FIG. 13 can be executed for each type of work to be assigned. As a result, there is a possibility that a plurality of pieces of work may be assigned to the same worker. In this case, for example, a procedure may be performed in such a manner that a piece of work having the longest standard work time 71 is assigned to a worker whose assignment score with respect to the work is the lowest and other works are assigned to the remaining workers.

Flow of Assistant Selection Processing

FIG. 14 is a flowchart illustrating an example of a flow of the assistant selection processing. First, the assistant selection unit 203 calculates the remaining work time of the work currently being performed by the worker R who is a candidate to be the assistant (ACT 60). Specifically, the remaining work time of the work currently being performed is calculated based upon the start time 43 of the work currently being performed as read from the work log file F4, the current time, and the standard work time 71 of the work read from the standard work time file F2.

Next, the assistant selection unit 203 calculates a distance between the worker Q requesting the assistance and the worker R who is the candidate assistant (ACT 61). When all the workers T are working in different stores, a distance between a store where the worker Q is working and a store where the worker R is working may be respectively calculated by location/coordinate. Further, when the worker Q and the worker R who is the candidate for the assistant are working in the same store, the distance therebetween may be calculated based upon layout information of the store.

The assistant selection unit 203 calculates a time conversion value for the distance calculated in ACT 61 (ACT 62). Specifically, when the worker R moves on foot to go for the assistance, for example, 1 km is converted into 15 minutes, thereby calculating the time conversion value. When the worker R moves by a vehicle to go for the assistance, the conversion is performed by a predetermined conversion method. Further, the time required to go for the assistance can be predicted or estimated by the processing of ACT 62.

Next, the assistant selection unit 203 reads the work experience 62 for the work type corresponding to the assistance request from the work result file F1 for each of the workers R who are candidates for the assistant (ACT 63).

The assistant selection unit 203 calculates a selection score for each worker R who becomes a candidate to be the assistant (ACT 64). The selection score is, for example, a value obtained by dividing the sum of the remaining work time calculated in ACT 60 and the time conversion value of the distance between the workers calculated in ACT 62 by the work experience 62 read in ACT 63. That is, when the work experience is the same, the selection score becomes a lower value as the remaining work time is smaller and the worker is closer to the worker who requested the assistance. Further, the selection score becomes a lower value as work experience 62 value is increases.

Next, the assistant selection unit 203 selects the worker S whose selection score is the lowest as the assistant (ACT 65). Thereafter, the processing proceeds to ACT 39 of FIG. 12.

As described above, in the server apparatus 10 according to the embodiment, the progress state estimation unit 201 estimates the progress of the current work of all the workers T based upon the past average work time of each worker with respect to the pieces of work respectively assigned to all the workers T, the start time 43 of the work currently being performed by each worker, and the current time. Further, the assistant selection unit 203 selects the worker S to assist the worker Q from among the workers R Y, based upon the information on the progress of the work of the workers R, distance between the worker Q and the worker R, and the ability of the worker R. Therefore, when a delay occurs in the work currently in progress, the delay can be most promptly solved.

Further, the server apparatus 10 according to an embodiment calculates the average work time 61 of each work type based upon the start time 43 and the end time 44 for all the workers T performing the same work in the past. The progress state estimation unit 201 can estimate the progress state of the work of the worker R with higher accuracy by using the average work time 61.

In the server apparatus 10 according to an embodiment, the assistant selection unit 203 selects the worker S who is to assist the worker Q from among the workers R based upon the estimated remaining work time for the work currently being performed by the worker R, the estimated travel time (based on distance between worksites, for example) required for the worker R to go to the worker Q for the assistance, and the work experience 62 of the worker R for the work type being performed by the worker Q. Therefore, it is possible to select the worker S providing the expected least influence (hindrance) on the progress of the overall work.

Further, in the server apparatus 10 according to an embodiment, the assistance request confirmation unit 202 confirms whether or not the assistance is necessary for the worker Q. The assistant selection unit 203 (selects the worker S who is to assist the worker Q if the worker Q replies that the assistance is necessary according to the confirmation of the assistant request confirmation unit 202. Therefore, it is possible to inquire of the worker Q about whether or not assistance is necessary before a delay in work progress becomes overly apparent.

Further, in the server apparatus 10 according to an embodiment, the work assignment unit 200) determines a worker to be assigned to work of a particular work type based upon the standard work time 71 required to complete work of the work type and the average work time 61 of each worker for work of the work type. Therefore, work can be assigned to all the workers T so that the overall work efficiency is improved.

Further, in the server apparatus 10 according to an embodiment, the communication control unit 205 receives the assistance request from the worker Q. The assistant selection unit 203 selects the worker S for performing the assistance from among the workers T other than the worker Q who issued an assistance request if the communication control unit 205 receives the assistance request. Therefore, the worker Q can also request assistance without waiting for the confirmation by the assistance request confirmation unit 202.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A maintenance management apparatus in communication with a plurality of portable terminals of workers, comprising:
a communication interface through which data are exchanged with the portable terminals; and
a processor configured to:
based on the data received through the communication interface from the portable terminals, estimate a current progress state of assigned work tasks being performed by each of a plurality of workers, the current progress state of each assigned work task being estimated based upon an average completion time for each worker with respect to work tasks of a same work type as the assigned work task, a start time of the assigned work task currently being performed by each worker, and the current time; and
select a second worker from the plurality of workers to assist a first worker currently performing an assigned work task having a current progress state that is estimated as delayed, the selection of the second worker being based upon the estimated current progress state of the assigned work task of the second worker, a distance between the first worker and the second worker, and information indicating an ability of the second worker with respect to the same work type as the assigned work task of the first worker.

2. The apparatus according to claim 1, wherein the average completion time is calculated based upon a start time and an end time for each worker who performed the same work type in the past.

3. The apparatus according to claim 1, wherein the selection of the second the worker is based upon an estimated remaining work time of the assigned work task currently being performed by the second worker, an estimated time for the second worker to go to the first worker, and the number of times the second worker has performed work of the same work type as the assigned work task being performed by the first worker.

4. The apparatus according to claim 1, wherein the processor is further configured to:
confirm whether the first worker requests assistance with the assigned work task currently being performed before selecting the second worker.

5. The apparatus according to claim 4, wherein the processor is configured to control a communication interface to send a confirmation request to a portable terminal of the first worker.

6. The apparatus according to claim 5, wherein the processor confirms whether the first worker requests assistance by receiving, via the communication interface, a communication from the portable terminal of the first worker after the confirmation request is sent.

7. The apparatus according to claim 1, wherein the processor is further configured to:
assign a work task of a first type to a worker based upon a standard completion time for the work task of the first work type and the average completion time for each worker of the plurality of workers for work tasks of the first type.

8. The apparatus according to claim 1, wherein the data received through the communication interface includes an assistance request from one of the portable terminals.

9. A maintenance management system, comprising:
a plurality of portable terminals for each of a plurality of workers, respectively; and
a server apparatus in communication with the plurality of portable terminals, said server apparatus including a communication interface through which data are exchanged with the portable terminals, and a processor configured to:
based on the data received from the portable terminals, estimate a current progress state of assigned work tasks being performed by each of a plurality of workers, the current progress state of each assigned work task being estimated based upon an average completion time for each worker with respect to work tasks of a same work type as the assigned work task, a start time of the assigned work task currently being performed by each worker, and the current time; and
select a second worker from the plurality of workers to assist a first worker currently performing an assigned work task having a current progress state that is estimated as delayed, the selection of the second worker being based upon the estimated current progress state of the assigned work task of the second worker, a distance between the first worker and the second worker, and information indicating an ability of the second worker with respect to the same work type as the assigned work task of the first worker, wherein
the processor is further configured to send an assistance confirmation request through the communication interface to a portable terminal of the first worker, and
the portable terminal of the first worker is configured to display a confirmation request screen upon receiving the assistance confirmation request.

10. The system according to claim 9, further comprising:
a storage device storing start times for each assigned work task currently being performed.

11. The system according to claim 9, wherein each portable terminal is configured to send the start time to the server when an assigned work task start button is pressed on the portable terminal.

12. The system according to claim 9, wherein the average completion time is calculated based upon a start time and an end time for each worker who performed the same work type in the past.

13. The system according to claim 9, wherein the selection of the second the worker is based upon an estimated remaining work time of the assigned work task currently being performed by the second worker, an estimated time for the second worker to go to the first worker, and the number of times the second worker has performed work of the same work type as the assigned work task being performed by the first worker.

14. The system according to claim 9, wherein the processor of the server is further configured to:
confirm whether the first worker requests assistance with the assigned work task currently being performed before selecting the second worker.

15. The system according to claim 14, wherein the processor of the server is configured to control a communication interface to send a confirmation request to the portable terminal of the first worker.

16. A maintenance management method, comprising:
in a server, estimating a current progress state of assigned work tasks being performed by each of a plurality of workers, the current progress state of each assigned work task being estimated based upon an average completion time for each worker with respect to work tasks of a same work type as the assigned work task, a start time of the assigned work task currently being performed by each worker, and the current time;
in the server, selecting a second worker from the plurality of workers to assist a first worker currently performing an assigned work task having a current progress state that is estimated as delayed, the selection of the second worker being based upon the estimated current progress state of the assigned work task of the second worker, a distance between the first worker and the second worker, and information indicating an ability of the second worker with respect to the same work type as the assigned work task of the first worker; and
sending a notification, from the server, to a portable terminal of the second worker indicating the second worker has been selected to assist the first worker.

17. The method according to claim 16, wherein the average completion time is calculated based upon a start time and an end time for each worker who performed the same work type in the past.

18. The method according to claim 16, wherein the second the worker is selected based upon an estimated remaining work time of the assigned work task currently being performed by the second worker, an estimated time for the second worker to go to the first worker, and the number of times the second worker has performed work of the same work type as the assigned work task being performed by the first worker.

19. The method according to claim. 16, further comprising:
in the server, confirming whether the first worker requests assistance with the assigned work task currently being performed before selecting the second worker.

20. The method according to claim 19, wherein a portable terminal of the first worker is configured to receive a notification from the server indicating that the progress state of an assigned work task has been estimated to be delayed by the server and display a screen requesting a confirmation as to whether assistance is required for the completion of the assigned work task.
